(19) United States
(12) Patent Application Publication
(10) Pub. No.: US 2006/0121228 A1
(43) Pub. Date: Jun. 8, 2006

(54) Tube container having barrier property

(76) Inventors: Myung Ho Kim, Daejeon-city (KR); Minki Kim, Daejeon-city (KR); Sehyun Kim, Daejeon-city (KR); Youngtock Oh, Daejeon-city (KR); Jaeyong Shin, Daejeon-city (KR); Youngchul Yang, Daejeon-city (KR)

Correspondence Address: CANTOR COLBURN, LLP, 55 GRIFFIN ROAD SOUTH, BLOOMFIELD, CT, 06002, US

(21) Appl. No.: 11/249,285

(22) Filed: Oct. 13, 2005

(30) Foreign Application Priority Data
Dec. 3, 2004 (KR) 10-2004-0101104
Jun. 2, 2005 (KR) 10-2005-0047118

(51) Int. Cl. B32B 1/08

(52) U.S. Cl. 428/36.9

(57) ABSTRACT

A tube container having a barrier property is provided. A single-layer or 3-layer tube container is manufactured by molding a dry-blended composition including a polyolefin resin and a nanocomposite of a resin having a barrier property and an intercalated clay, and a compatibilizer. The single-layer or 3-layer tube container can be simply manufactured and has a superior barrier property, thereby preventing the decomposition of contents, compared to a conventional 5-layer tube container.

### CROSS-REFERENCE TO RELATED PATENT APPLICATION

This application claims the benefit of Korean Patent Application No. 10-2004-0101104, filed on Dec. 3, 2004, and Korean Patent Application No. 10-2005-0047118, filed on Jun. 2, 2005, in the Korean Intellectual Property Office, the disclosures of which are incorporated herein in their entirety by reference.

### BACKGROUND OF THE INVENTION

1. Field of the Invention

The present invention relates to a tube container having a barrier property, manufactured from a dry-blended composition including a polyolefin resin, a nanocomposite of an intercalated clay and a resin having a barrier property, and a compatibilizer.

2. Description of the Related Art

Tube containers are used as containers for packaging toothpastes, cosmetics, foods and various industrial products. Most materials contained in tube containers require good flavor retention, oxygen barrier property, and moisture proof property of containers.

Conventionally, laminated tube containers molded from a laminated sheet in which paper or a thermoplastic resin is deposited on an aluminum foil, or multi-layer blow-molded tube containers having a layer of a resin having a barrier property, for example, a layer of a gelled ethylene-vinyl acetate copolymer have been used.

Multi-layer tube containers having a layer of a resin having a barrier property, such as an ethylene/vinyl alcohol copolymer (EVOH) are also being used. A representative multi-layer tube container is a container manufactured from a 5-layer LDPE/adhesive/EVOH/adhesive/LDPE structure.

However, since co-extrusion should be performed using 5 extruders in order to manufacture the 5-layer tube container, it is difficult to obtain a uniform thickness when extruding layers. In addition, high costs are required to provide equipment for producing the 5-layer tube container.

Meanwhile, when a nano-sized intercalated clay is mixed with a polymer matrix to form a fully exfoliated, partially exfoliated, intercalated, or partially intercalated nanocomposite, it has an improved barrier property due to its morphology. Thus, an article having a barrier property using such a nanocomposite is emerging.

### SUMMARY OF THE INVENTION

The present invention provides a tube container which has a superior barrier property and can be simply and conveniently manufactured by using a nanocomposite having superior oxygen barrier property, moisture resistance and flavor retention, including an intercalated clay and a resin having a barrier property.

According to an aspect of the present invention, there is provided a tube container having a barrier property manufactured from a dry-blended composition including: 40 to 98 parts by weight of a polyolefin resin; 0.5 to 60 parts by weight of a nanocomposite having a barrier property, including an intercalated clay and at least one resin having a barrier property, selected from the group consisting of an ethylene-vinyl alcohol (EVOH) copolymer, a polyamide, an ionomer and a polyvinyl alcohol (PVA); and 1 to 30 parts by weight of a compatibilizer.

In an embodiment of the present invention, the polyolefin resin may be at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer or copolymer of propylene, metallocene polypropylene, and a composite resin prepared by adding talc, flame retardant, etc. to homopolymer or copolymer of propylene.

In another embodiment of the present invention, the intercalated clay may be at least one material selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

In another embodiment of the present invention, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

In another embodiment of the present invention, the ionomer may have a melt index of 0.1 to 10 g/10 min (190° C., 2,160 g).

In another embodiment of the present invention, the compatibilizer may be at least one compound selected from an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer.

According to another aspect of the present invention, there is provided a 3-layered tube container including an innermost layer, a barrier layer, and an outermost layer, in which the barrier layer is prepared from a dry-blended composition including: 40 to 98 parts by weight of a polyolefin resin; 0.5 to 60 parts by weight of a nanocomposite having a barrier property, including an intercalated clay and at least one resin having a barrier property, selected from the group consisting of an ethylene-vinyl alcohol (EVOH) copolymer, a polyamide, an ionomer and a polyvinyl alcohol (PVA); and 1 to 30 parts by weight of a compatibilizer.

In an embodiment of the present invention, the innermost and the outermost layers may be composed of a polyolefin resin.

In another embodiment of the present invention, the innermost layer may have a thickness of 10 to 300 μm, the outermost layer may have a thickness of 10 to 300 μm, and the barrier layer may have a thickness of 10 to 100 μm.

### DETAILED DESCRIPTION OF THE INVENTION

The present invention will now be explained in more detail.

A tube container having a barrier property according to an embodiment of the present invention is manufactured from a dry-blended composition including: 40 to 98 parts by weight of a polyolefin resin; 0.5 to 60 parts by weight of a nanocomposite having a barrier property, including an intercalated clay and at least one resin having a barrier property, selected from the group consisting of an ethylene-vinyl alcohol (EVOH) copolymer, a polyamide, an ionomer and a polyvinyl alcohol (PVA); and 1 to 30 parts by weight of a compatibilizer.

The polyolefin resin may include at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, flame retardant, etc. to a homopolymer or copolymer of propylene.

The content of the polyolefin resin is preferably 40 to 98 parts by weight, and more preferably 60 to 96 parts by weight. If the content of the polyolefin resin is less than 40 parts by weight, the adhesion to the innermost layer and the outermost layer is reduced, and thus peeling occurs. If the content of the polyolefin resin is greater than 98 parts by weight, the barrier property is not significantly improved.

The nanocomposite having a barrier property may be prepared by mixing an intercalated clay with at least one resin selected from the group consisting of an ethylene-vinyl alcohol (EVOH) copolymer, a polyamide, an ionomer and a polyvinyl alcohol (PVA).

The weight ratio of the resin having a barrier property to the intercalated clay in the nanocomposite is 58.0:42.0 to 99.9:0.1, and preferably 85.0:15.0 to 99.0:1.0. If the weight ratio of the resin having a barrier property to the intercalated clay is less than 58.0:42.0, the intercalated clay agglomerates and dispersing is difficult. If the weight ratio of the resin having a barrier property to the intercalated clay is greater than 99.9:0.1, the improvement in the barrier properties is negligible.

The intercalated clay is preferably organic intercalated clay. The content of an organic material in the intercalated clay is preferably 1 to 45 wt %. When the content of the organic material is less than 1 wt %, the compatibility of the intercalated clay and the resin having a barrier property is poor. When the content of the organic material is greater than 45 wt %, the intercalation of the resin having a barrier property is difficult.

The organic material has at least one functional group selected from the group consisting of primary ammonium to quaternary ammonium, phosphonium, maleate, succinate, acrylate, benzylic hydrogen, oxazoline, and dimethyldistearylammonium.

The intercalated clay includes at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from primary ammonium to quaternary ammonium, phosphonium, maleate, succinate, acrylate, benzylic hydrogen, oxazoline, and dimethyldistearylammonium.

If an ethylene-vinyl alcohol copolymer is included in the nanocomposite, the content of ethylene in the ethylene-vinyl alcohol copolymer is preferably 10 to 50 mol %. If the content of ethylene is less than 10 mol %, melt molding becomes difficult due to poor processability. If the content of ethylene exceeds 50 mol %, oxygen and liquid barrier properties are insufficient.

If polyamide is included in the nanocomposite, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

The amorphous polyamide refers to a polyamide having insufficient crystallinity, that is, not having an endothermic crystalline melting peak when measured by a differential scanning calorimetry (DSC) (ASTM D-3417, 10° C./min).

In general, the polyamide can be prepared using diamine and dicarboxylic acid. Examples of the diamine include hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidene, 1,4-diaminocyclohexane, 1,3-diaminocyclohexane, meta-xylenediamine, 1,5-diaminopentane, 1,4-diaminobutane, 1,3-diaminopropane, 2-ethyldiaminobutane, 1,4-diaminomethylcyclohexane, methane-xylenediamine, alkyl-substituted or unsubstituted m-phenylenediamine and p-phenylenediamine, etc. Examples of the dicarboxylic acid include alkyl-substituted or unsubstituted isophthalic acid, terephthalic acid, adipic acid, sebacic acid, butanedicarboxylic acid, etc.

Polyamide prepared using aliphatic diamine and aliphatic dicarboxylic acid is general semicrystalline polyamide (also referred to as crystalline nylon) and is not amorphous polyamide. Polyamide prepared using aromatic diamine and aromatic dicarboxylic acid is not easily treated using a general melting process.

Thus, amorphous polyamide is preferably prepared, when one of diamine and dicarboxylic acid used is aromatic and the other is aliphatic. Aliphatic groups of the amorphous polyamide are preferably C₁-C₁₅ aliphatic or C₄-C₈ alicyclic alkyls. Aromatic groups of the amorphous polyamide are preferably mono- or bicyclic aromatic groups having C₁-C₆ substituents. However, all the above amorphous polyamide is not preferable in the present invention. For example, metaxylenediamine adipamide is easily crystallized when heated during a thermal molding process or when oriented, therefore, it is not preferable.

Examples of preferable amorphous polyamides include hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, a copolymer of hexamethylenediamine or 2-methylpentamethylenediamine and an isophthalic acid, terephthalic acid or mixtures thereof. While polyamide based on hexamethylenediamine isophthalamide/terephthalamide, which has a high terephthalic acid content, is useful, it should be mixed with another diamine such as 2-methyldiaminopentane in order to produce an amorphous polyamide that can be processed.

The above amorphous polyamide comprising only the above monomers may contain a small amount of lactam, such as caprolactam or lauryl lactam, as a comonomer. It is important that the polyamide be amorphous. Therefore, any comonomer that does not crystallize polyamide can be used. About 10 wt % or less of a liquid or solid plasticizer, such as glycerole, sorbitol, or toluenesulfoneamide (Santicizer 8 monsanto) can also be included in the amorphous polyamide. For most applications, a glass transition temperature Tg (measured in a dried state, i.e., with a water content of about 0.12 wt % or less) of amorphous polyamide is about 70-170° C., and preferably about 80-160° C. The amorphous polyamide, which is not blended, has a Tg of approximately 125° C. in a dried state. The lower limit of Tg is not clear, but 70° C. is an approximate lower limit. The upper limit of Tg is not clear, too. However, when polyamide with a Tg of about 170° C. or greater is used, thermal molding is difficult. Therefore, polyamide having both an acid and an amine having aromatic groups cannot be thermally molded due to too high Tg, and thus, is not suitable for the purposes of the present invention.

The polyamide may also be a semicrystalline polyamide. The semicrystalline polyamide is generally prepared using lactam, such as nylon 6 or nylon 11, or an amino acid, or is prepared by condensing diamine, such as hexamethylenediamine, with dibasic acid, such as succinic acid, adipic acid, or sebacic acid. The polyamide may be a copolymer or a terpolymer such as a copolymer of hexamethylenediamine/adipic acid and caprolactame (nylon 6, 66). A mixture of two or more crystalline polyamides can also be used. The semicrystalline and amorphous polyamides are prepared by condensation polymerization well-known in the art.

If an ionomer is included in the nanocomposite, the ionomer is preferably a copolymer of acrylic acid and ethylene, with a melt index of 0.1 to 10 g/10 min (190° C., 2,160 g).

The content of the nanocomposite is preferably 0.5 to 60 parts by weight, and more preferably 4 to 50 parts by weight. If the content of the nanocomposite is less than 0.5 part by weight, an improvement of barrier properties is negligible. If the content of the nanocomposite is greater than 60 parts by weight, the adhesion to the innermost and outmost polyolefin layers is reduced, and thus peeling occurs.

The finer the intercalated clay is exfoliated in the resin having barrier property in the nanocomposite, the better the barrier properties that can be obtained. This is because the exfoliated intercalated clay forms a barrier film and thereby improves barrier properties and mechanical properties of the resin itself, and ultimately improves barrier properties and mechanical properties of a molded article prepared from the composition. Accordingly, the ability to form a barrier to gas and liquid is maximized by compounding the resin having a barrier property and the intercalated clay, and dispersing the nano-sized intercalated clay in the resin, thereby maximizing the contact area of the polymer chain and the intercalated clay.

The compatibilizer improves the compatibility of the polyolefin resin in the nanocomposite to form a stable composition.

The compatibilizer may be a hydrocarbon polymer having polar groups. When a hydrocarbon polymer having polar groups is used, the hydrocarbon polymer portion increases the affinity of the compatibilizer to the polyolefin resin and to the nanocomposite having a barrier property to form a stable composition.

The compatibilizer can include an compound selected from an epoxy-modified polystyrene copolymer, an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer, and a modification thereof.

The content of the compatibilizer is preferably 1 to 30 parts by weight, and more preferably 2 to 25 parts by weight. If the content of the compatibilizer is less than 1 part by weight, the mechanical properties of a molded article from the composition are poor. If the content of the compatibilizer is greater than 30 parts by weight, the barrier property is poor.

When an epoxy-modified polystyrene copolymer is used as the compatibilizer, a copolymer comprising a main chain which comprises 70 to 99 parts by weight of styrene and 1 to 30 part by weight of an epoxy compound represented by Formula 1, and branches which comprise 1 to 80 parts by weight of acrylic monomers represented by Formula 2, is preferable.

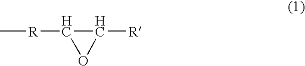

where each of R and R′ is independently a C₁-C₂₀ aliphatic residue or a C₅-C₂₀ aromatic residue having double bonds at its termini

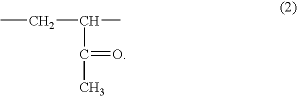

Each of the maleic anhydride modified (graft) high-density polyethylene, maleic anhydride modified (graft) linear low-density polyethylene, and maleic anhydride modified (graft) ethylene-vinyl acetate copolymer preferably comprises branches having 0.1 to 10 parts by weight of maleic anhydride based on 100 parts by weight of the main chain. When the content of the maleic anhydride is less than 0.1 part by weight, it does not function as the compatibilizer. When the content of the maleic anhydride is greater than 10 parts by weight, it is not preferable due to an unpleasant odor.

The composition of the present invention is prepared by dry-blending the nanocomposite having a barrier property in a pellet form, the compatibilizer and the polyolefin resin at a constant compositional ratio in a pellet mixer.

The composition is extruded using an extruder while maintaining the barrier property morphology to provide a tube container having a barrier property.

The tube container may be manufactured through a general molding method including extrusion molding, pressure molding, blow molding, or injection molding.

A 3-layer tube container according to another embodiment includes an innermost layer, a barrier layer, and an outermost layer, in which the barrier layer is prepared from a dry-blended composition including: 40 to 98 parts by weight of a polyolefin resin; 0.5 to 60 parts by weight of a nanocomposite having a barrier property, including an intercalated clay and at least one resin having a barrier property, selected from the group consisting of an ethylene-vinyl alcohol (EVOH) copolymer, a polyamide, an ionomer and a polyvinyl alcohol (PVA); and 1 to 30 parts by weight of a compatibilizer.

The innermost layer and the outermost layer may be composed of a polyolefin resin, preferably low density polyethylene.

The thickness of the outermost layer may be 10 to 300 μm, the thickness of the innermost layer may be 10 to 300 μm, and the thickness of the barrier layer may be 10 to 100 μm.

The 3-layer tube container has better moisture and alcohol barrier properties and better appearance than a single-layer tube comprising only the nanocomposite composition of the present invention.

A conventional 5-layer tube container generally includes an outermost layer, an adhesive layer, a barrier layer, an adhesive layer, and an innermost layer. In such a structure, a polyolefin resin generally used as the outermost layer has low adhesion to an ethylene-vinyl alcohol copolymer or a polyamide resin used as the barrier layer, and thus inter-layer peeling occurs. For this reason, the adhesive layer should be interposed between the outermost layer and the barrier layer or between the innermost layer and the barrier layer. On the contrary, the barrier layer formed using the nanocomposite composition of the present invention has good adhesion to the outermost and innermost layers, and thus the adhesive layer is not required, thereby providing a 3-layer tube container.

A method of manufacturing the 3-layer tube container will now be described.

The 3-layer tube container can be manufactured using a plurality of extruders that can separately melt resins for the innermost layer, the outermost layer and the nanocomposite composition layer by melting each resin and co-extruding the molten resin from each end of the extruders while maintaining the barrier property morphology, and then solidifying the extrudate by cooling.

Hereinafter, the present invention is described in more detail through examples. The following examples are meant only to increase understanding of the present invention, and are not meant to limit the scope of the invention.

### EXAMPLES

The materials used in the following examples are as follows:

EVOH: E105B (Kuraray, Japan)

Nylon 6: EN 500 (KP Chemicals)

LDPE-g-MAH: Compatibilizer, PB3109 (CRAMPTON)

LDPE: FB0390 (LG CHEM)

Clay: Closite 30B (SCP)

Thermal stabilizer: IR 1098 (Songwon Inc.)

### Preparation Example 1

(Preparation of EVOH/Intercalated Clay Nanocomposite)

97 wt % of an ethylene-vinyl alcohol copolymer (EVOH; E-105B (ethylene content: 44 mol %); Kuraray, Japan; melt index: 5.5 g/10 min; density: 1.14 g/cm³) was put in the main hopper of a twin screw extruder (SM Platek co-rotation twin screw extruder; Φ 40). Then, 3 wt % of organic montmorillonite (Southern Intercalated Clay Products, USA; C2OA) as an intercalated clay and 0.1 part by weight of IR 1098 as a thermal stabilizer based on total 100 parts by weight of the EVOH copolymer and the organic montmorillonite were separately put in the side feeder of the twin screw extruder to prepare an EVOH/intercalated clay nanocomposite in a pellet form. The extrusion temperature condition was 180-190-200-200-200-200-200° C., the screws were rotated at 300 rpm, and the discharge condition was 15 kg/hr.

### Preparation Example 2

(Preparation of Nylon 6/Intercalated Clay Nanocomposite)

97 wt % of a polyamide (nylon 6) was put in the main hopper of a twin screw extruder (SM Platek co-rotation twin screw extruder; Φ 40). Then, 3 wt % of organic montmorillonite as an intercalated clay and 0.1 part by weight of IR 1098 as a thermal stabilizer based on total 100 parts by weight of the polyamide and the organic montmorillonite were separately put in the side feeder of the twin screw extruder to prepare a polyamide/intercalated clay nanocomposite in a pellet form. The extrusion temperature condition was 220-225-245-245-245-245-245° C., the screws were rotated at 300 rpm, and the discharge condition was 40 kg/hr.

### Example 1

30 parts by weight of the EVOH/intercalated clay nanocomposite obtained in the Preparation Example 1, 4 parts by weight of a compatibilizer, and 66 parts by weight of LDPE were dry-blended in a double cone mixer (MYDCM-100, MYEONG WOO MICRON SYSTEM) for 30 minutes and put into the main hopper of a single screw extruder (Goetffert Φ 45, L/D: 23) to manufacture a tube container. The extrusion temperature condition was 190-210-210-210-210° C., the screw was rotated at 20 rpm, and the discharge condition was 6 kg/hr.

### Example 2

30 parts by weight of the nylon 6/intercalated clay nanocomposite obtained in the Preparation Example 2, 4 parts by weight of a compatibilizer, and 66 parts by weight of LDPE were dry-blended in a double cone mixer (MYDCM-100, MYEONG WOO MICRON SYSTEM) for 30 minutes and put into the main hopper of a single screw extruder (Goetffert Φ 45) to manufacture a tube with a diameter of 30 mm, a length of 125 mm and a thickness of 500 μm. Under the extrusion temperature condition of 210-220-220-220-222° C., the screw was rotated at 20 rpm, and the discharge condition was 6 kg/hr.

### Example 3

30 parts by weight of the EVOH/intercalated clay nanocomposite obtained in the Preparation Example 1, 4 parts by weight of a compatibilizer, and 66 parts by weight of HDPE were dry-blended in a double cone mixer (MYDCM-100, MYEONG WOO MICRON SYSTEM) for 30 minutes and put into a middle layer extruder of a 3-layer tube extruder (SHT-50, SEHAN). LDPE (5301, HANWHA) was put into inside and outside extruders of the 3-layer tube extruder and co-extrusion was performed to manufacture a tube with a diameter of 30 mm, a length of 125 mm and a thickness of 500 μm. A screw compression ratio of the middle layer extruder was 3.2:1 and the extrusion temperature condition of the middle layer extruder was 190-210-210-210-210° C.

The thickness of the middle layer measured through an electron microscope was 50 μm.

### Example 4

30 parts by weight of the nylon 6/intercalated clay nanocomposite obtained in the Preparation Example 2, 4 parts by weight of a compatibilizer, and 66 parts by weight of HDPE were dry-blended in a double cone mixer (MYDCM-100, MYEONG WOO MICRON SYSTEM) for 30 minutes and put into a middle layer extruder of a 3-layer tube extruder (SHT-50, SEHAN). LDPE was put into inside and outside extruders of the 3-layer tube extruder and co-extrusion was performed to manufacture a tube with a diameter of 30 mm, a length of 125 mm and a thickness of 500 μm. A screw compression ratio of the middle layer extruder was 3.2:1 and the extrusion temperature condition of the middle layer extruder was 190-210-210-210-210° C.

### Example 5

30 parts by weight of the nylon 6/intercalated clay nanocomposite obtained in the Preparation Example 2, 4 parts by weight of a compatibilizer, and 66 parts by weight of HDPE were put into a main hopper of a middle layer extruder of a 3-layer tube extruder (SHT-50, SEHAN) through belt-type feeders K-TRON Nos. 1, 2, and 3, respectively, in a dry-blend state. LDPE was put into inside and outside extruders of the 3-layer tube extruder and co-extrusion was performed to manufacture a tube with a diameter of 30 mm, a length of 125 mm and a thickness of 500 μm. A screw compression ratio of the middle layer extruder was 3.2:1 and the extrusion temperature condition of the middle layer extruder was 190-210-210-210-210° C.

The thickness of the middle layer measured through an electron microscope was 50 μm.

### Example 6

4 parts by weight of the nylon 6/intercalated clay nanocomposite obtained in the Preparation Example 2, 2 parts by weight of a compatibilizer, and 96 parts by weight of HDPE were dry-blended in a double cone mixer (MYDCM-100, MYEONG WOO MICRON SYSTEM) for 30 minutes and put into a middle layer extruder of a 3-layer tube extruder (SHT-50, SEHAN). LDPE (5301, HANWHA) was put into inside and outside extruders of the 3-layer tube extruder and co-extrusion was performed to manufacture a tube with a diameter of 30 mm, a length of 125 mm and a thickness of 500 μm. A screw compression ratio of the middle layer extruder was 3.2:1 and the extrusion temperature condition of the middle layer extruder was 190-210-210-210-210° C.

The thickness of the middle layer measured through an electron microscope was 50 μm.

### Example 7

45 parts by weight of the nylon 6/intercalated clay nanocomposite obtained in the Preparation Example 2, 15 parts by weight of a compatibilizer, and 40 parts by weight of HDPE were dry-blended in a double cone mixer (MYDCM-100, MYEONG WOO MICRON SYSTEM) for 30 minutes and put into a middle layer extruder of a 3-layer tube extruder (SHT-50, SEHAN). LDPE was put into inside and outside extruders of the 3-layer tube extruder and co-extrusion was performed to manufacture a tube with a diameter of 30 mm, a length of 125 mm and a thickness of 500 μm. A screw compression ratio of the middle layer extruder was 3.2:1 and the extrusion temperature condition of the middle layer extruder was 190-210-210-210-210° C.

The thickness of the middle layer measured through an electron microscope was 50 μm.

### Comparative Example 1

LDPE, an adhesive (admer), EVOH, an adhesive (admer), and LDPE were put into each hopper of 5 extruders of a 5-layer tube extruder (SHT-35, SEHAN) and co-extrusion was performed to manufacture a tube with a diameter of 30 mm, a length of 125 mm and a thickness of 500 μm. A screw compression ratio of the middle layer (EVOH layer) extruder was 3.2:1 and the extrusion temperature condition of the middle layer extruder was 190-210-210-210-210° C.

The thickness of the middle layer measured through an electron microscope was 50 μm. Finally, a tube container with a 5-layer LDPE/adhesive(admer)/EVOH/adhesive(admer)/LDPE (190/35/50/35/190) structure was manufactured.

### Comparative Example 2

EVOH was put into a middle layer extruder of a 3-layer tube extruder (SHT-50, SEHAN) and LDPE was put into inside and outside extruders of the 3-layer tube extruder. Co-extrusion was performed to manufacture a tube with a diameter of 30 mm, a length of 125 mm and a thickness of 500 μm. A screw compression ratio of the middle layer extruder was 3.2:1 and the extrusion temperature condition of the middle layer extruder was 190-210-210-210-210° C.

The thickness of the middle layer measured through an electron microscope was 50 μm.

The barrier property and the peeling strength of the tube containers manufactured in Examples 1-7 and Comparative Example 1 and 2 were determined using the following methods. The results are shown in Tables 1 and 2.

Barrier Property

The tube containers manufactured in Examples 1-7 and Comparative Example 1 and 2 were charged with 80 g of each of a lotion (LacVert, LG Household & Health Care) and a sun cream (UV Screen EN1, LG Household & Health Care), and then thermally sealed at both ends. Then, the tube containers were let alone in a dry-oven at 50° C. for 30 days and the weight change was determined.

Peeling Strength

Immediately after determining the weight change, the contents of the tube containers were removed. After 5 minutes, a specimen with a width of 15 mm was cut from a side of the tube and the adhesion of the inside layer to the middle layer was measured in thermostatic chambers with temperatures of 30° C. and 80° C. This test was performed using a T-peeling method at a peeling rate of 50 mm/min.

TABLE 1
Reduction in weight (g)

| | Lotion | Sun cream |
|---|---|---|
| Example 1 | 0.191 | 0.688 |
| Example 2 | 0.236 | 0.696 |
| Example 3 | 0.210 | 0.738 |
| Example 4 | 0.244 | 0.810 |
| Example 5 | 0.249 | 0.811 |
| Example 6 | 0.251 | 0.843 |
| Example 7 | 0.195 | 0.594 |
| Comparative Example 1 | 0.253 | 0.852 |
| Comparative Example 2 | 0.446 | 1.822 |

TABLE 2
Peeling strength (gf/25 mm)

| | 30 degrees | 80 degrees |
|---|---|---|
| Example 3 | 8140 | 2100 |
| Example 4 | 8280 | 2320 |
| Example 5 | 8310 | 2340 |
| Example 6 | 8490 | 2540 |
| Example 7 | 6240 | 1780 |
| Comparative Example 1 | 6210 | 1750 |
| Comparative Example 2 | 830 | 170 |

As shown in Tables 1 and 2, the tube containers of Examples 1 to 7 have a superior barrier property compared to those of Comparative Examples 1 and 2 and the 3-layer tube containers of Examples 3 to 7 have a higher peeling strength than the tube containers of Comparative Examples 1 and 2.

The tube container according to the present invention has a superior barrier property and a high peeling strength.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A tube container having a barrier property manufactured by molding a dry-blended composition comprising:
40 to 98 parts by weight of a polyolefin resin;
0.5 to 60 parts by weight of a nanocomposite having a barrier property, comprising an intercalated clay and at least one resin having a barrier property selected from the group consisting of an ethylene-vinyl alcohol (EVOH) copolymer, a polyamide, an ionomer and a polyvinyl alcohol (PVA); and
1 to 30 parts by weight of a compatibilizer.

2. The tube container of claim 1, wherein the polyolefin resin is at least one compound selected from the group consisting of a high density polyethylene (HDPE), a low density polyethylene (LDPE), a linear low density polyethylene (LLDPE), an ethylene-propylene copolymer, metallocene polyethylene, and polypropylene.

3. The tube container of claim 1, wherein the weight ratio of the resin having a barrier property to the intercalated clay in the nanocomposite is 58.0:42.0 to 99.9:0.1.

4. The tube container of claim 1, wherein the intercalated clay is at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

5. The tube container of claim 1, wherein the intercalated clay comprises 1 to 45 wt % of an organic material.

6. The tube container of claim 5, wherein the organic material has at least one functional group selected from the group consisting of primary ammonium to quaternary ammonium, phosphonium, maleate, succinate, acrylate, benzylic hydrogen, oxazoline, and dimethyldistearylammonium.

7. The tube container of claim 1, wherein the ethylene-vinyl alcohol copolymer contains 10 to 50 mol % of ethylene.

8. The article having barrier properties of claim 1, wherein the polyamide is nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

9. The tube container of claim 8, wherein the glass transition temperature of the amorphous polyamide is about 70-170° C.

10. The tube container of claim 8, wherein the amorphous polyamide is selected from the group consisting of hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, and a copolymer of hexamethylenediamine or 2-methylpentamethylenediamine and isophthalic acid, terephthalic acid, or a mixture thereof.

11. The tube container of claim 10, wherein the amorphous polyamide is hexamethylene diamine isophthalamide/terephthalamide terpolymer having a ratio of isophthalic acid to terephthalic acid of 70:30.

12. The tube container of claim 1, wherein the ionomer has a melt index of 0.1 to 10 g/10 min (190° C., 2,160 g).

13. The tube container of claim 1, wherein the compatibilizer is one or more compounds selected from the group consisting of an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, and a maleic anhydride modified (graft) ethylene-vinyl acetate copolymer.

14. The tube container of claim 1, which is manufactured through extrusion molding, pressure molding, blow molding or injection molding.

15. A 3-layer tube container comprising an innermost layer, a barrier layer, and an outermost layer,
wherein the barrier layer is prepared from a dry-blended composition comprising:
40 to 98 parts by weight of a polyolefin resin;
0.5 to 60 parts by weight of a nanocomposite having a barrier property, comprising an intercalated clay and at least one resin having a barrier property, selected from the group consisting of an ethylene-vinyl alcohol (EVOH) copolymer, a polyamide, an ionomer and a polyvinyl alcohol (PVA); and
1 to 30 parts by weight of a compatibilizer.

16. The 3-layer tube container of claim 15, wherein the innermost layer and the outermost layer are composed of a polyolefin resin.

17. The 3-layer tube container of claim 16, wherein the innermost layer and the outermost layer are composed of low density polyethylene.

18. The 3-layer tube container of claim 15, wherein the thickness of the outermost layer is 10 to 300 μm, the thickness of the innermost layer is 10 to 300 μm, and the thickness of the barrier layer is 10 to 100 μm.
